(19) United States
(12) Patent Application Publication
(10) Pub. No.: US 2018/0119455 A1
(43) Pub. Date: May 3, 2018

(54) LATCH STYLE LOCK THAT SECURES ROLLING CARGO DOOR

(71) Applicant: JOSHUA J. MILLER, Brookfield, WI (US)

(72) Inventor: JOSHUA J. MILLER, Brookfield, WI (US)

(21) Appl. No.: 15/800,729

(22) Filed: Nov. 1, 2017

Related U.S. Application Data
(60) Provisional application No. 62/416,377, filed on Nov. 2, 2016.

(51) Int. Cl. E05B 63/00; E05B 15/02

(52) U.S. Cl. CPC E05B 63/0052; E05B 15/0295

(57) ABSTRACT

A latch style lock assembly is adapted to secure a space enclosed by a roll up door. The lock assembly includes a striker adapted to be attached to the door, and a lock. The lock includes a catch pivotally mounted on a frame plate and movable between a striker accept position and a striker received position, the lock being adapted to be positioned where the catch can receive and hold the striker. A pawl is pivotally mounted on the frame plate and movable between a catch release position and a catch lock position. The lock also includes an actuator bracket extending from an actuator, the actuator bracket is movable to engage the pawl and move the pawl.

### BACKGROUND

The present disclosure relates generally to locks and to other security devices that use locks and locking mechanisms. It also relates generally to doors, such as roll top doors and trailer doors, used to enclose a space for storing various items.

### SUMMARY

Disclosed is a latch style lock assembly adapted to secure a space enclosed by a door. The lock assembly includes a striker adapted to be attached to the door, and a lock. The lock includes a catch pivotally mounted on a frame plate and movable between a striker accept position and a striker received position, the lock being adapted to be positioned where the catch can receive and hold the striker. A pawl is pivotally mounted on the frame plate and movable between a catch release position and a catch lock position. The lock also includes an actuator bracket extending from an actuator, and the actuator bracket is movable to engage the pawl and move the pawl.

### BRIEF DESCRIPTION OF THE DRAWINGS

FIG. 1A is a right side perspective view of a cargo door locking system, and FIG. 1B is a left side perspective view of the cargo door locking system.

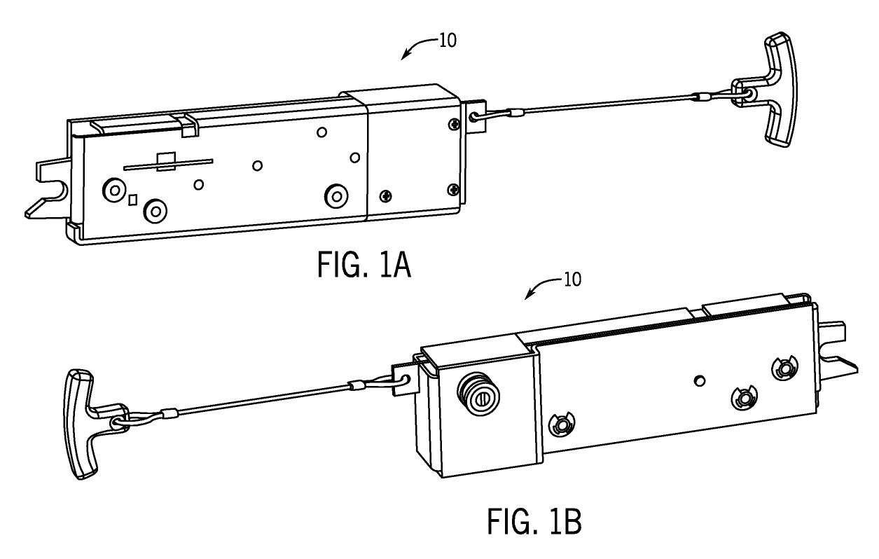

FIG. 2 is a perspective view of a partial corner of a cargo storage area, illustrating a cargo area side wall and a rolling door for securing the cargo area.

FIG. 3 is an enlarged perspective view of the lock capturing a striker.

FIG. 4A shows the rock prior to receiving the striker, and FIG. 4B shows the lock after receiving the striker.

FIG. 5 is an exploded view of the lock.

FIG. 6 is a side perspective view of a portion of the cargo lock in an unlatched door open position.

FIG. 7 is a side perspective view of a portion of the cargo lock assembly in a mid-travel, door closing position.

FIG. 8 is a side perspective view of a portion of the cargo lock assembly in a latch locked, door dosed position.

FIG. 9 is a side perspective view of a portion of the cargo lock assembly In an FOB unlocked, door closed position.

FIG. 10 is a side perspective view of a portion of the cargo lock assembly in an FOB unlocked, door closed position.

FIG. 11 is a side perspective view of a portion of the cargo lock assembly in a cargo safe unlocked, door opening position.

FIG. 12 is a side perspective view of a portion of the cargo lock assembly in an unlocking with lock and key position.

FIG. 13 is a side perspective view of a portion of the cargo lock assembly in an unlocking with manual release handle position.

FIG. 14 is a rear perspective view of a space, such as a cargo area, partially enclosed by a roll up door.

Before one embodiment of the disclosure is explained in detail, it is to be understood that the disclosure is not limited in its application to the details of the construction and the arrangements of components set forth in the following description or illustrated in the drawings. The disclosure is capable of other embodiments and of being practiced or being carried out in various ways. Also, it is to be understood that the phraseology and terminology used herein is for the purpose of description and should not be regarded as limiting. Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof. Further, it is to be understood that such terms as “forward”, “rearward”, “left”, “right”, “upward”, “downward”, “side”, “top” and “bottom”, etc., are words of convenience and are not to be construed as limiting terms.

### DETAILED DESCRIPTION

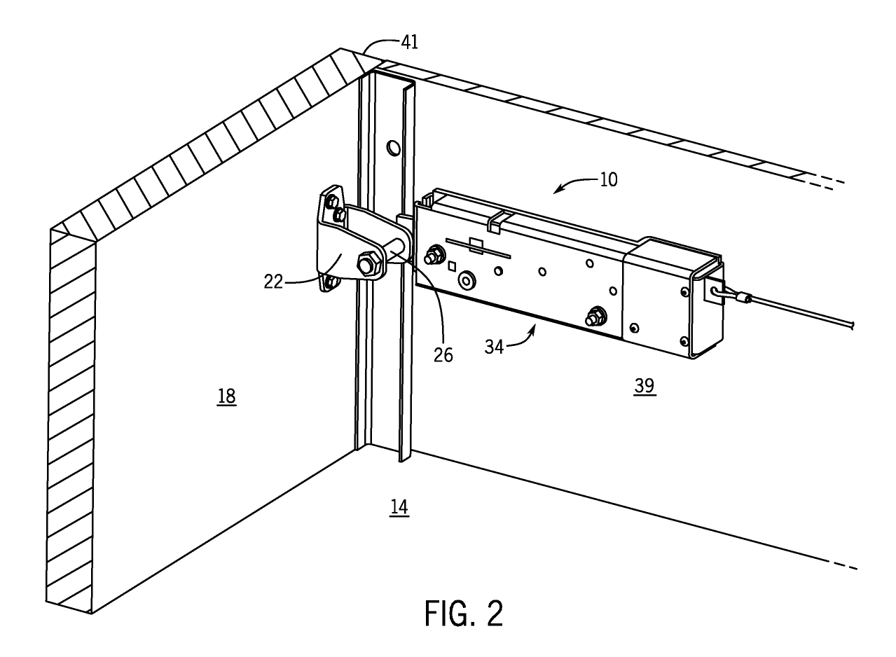

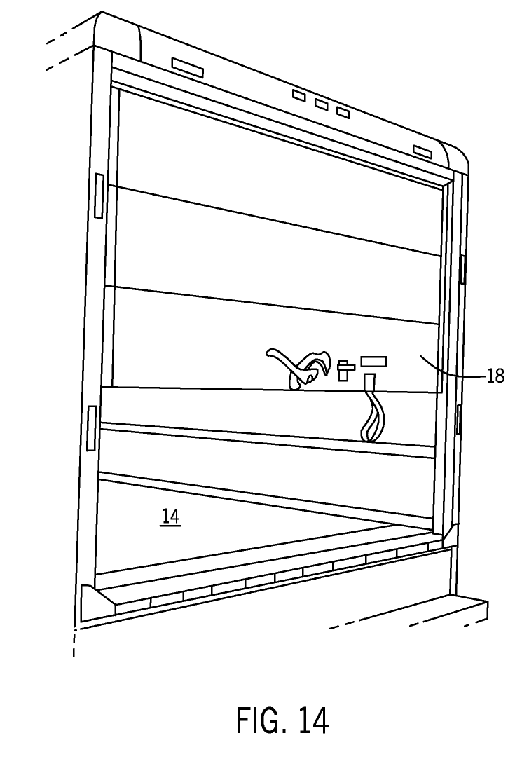

Disclosed in the drawings is a cargo door locking system in the form of a latch style lock assembly 10 adapted to secure a space 14 partially enclosed by a door, such as a roil up door 18, as shown in FIG. 14. As illustrated in FIG. 2, the lock assembly 10 comprises a striker 26 adapted to be attached to the door 18, and a lock 34. The lock assembly 10 can also include a striker bracket 22 adapted to be attached to the door 18, the striker 28 being mounted within the striker bracket 22. In other embodiments (not shown), a door hinge pin, in a location similar to the illustrated striker, can be used as the striker.

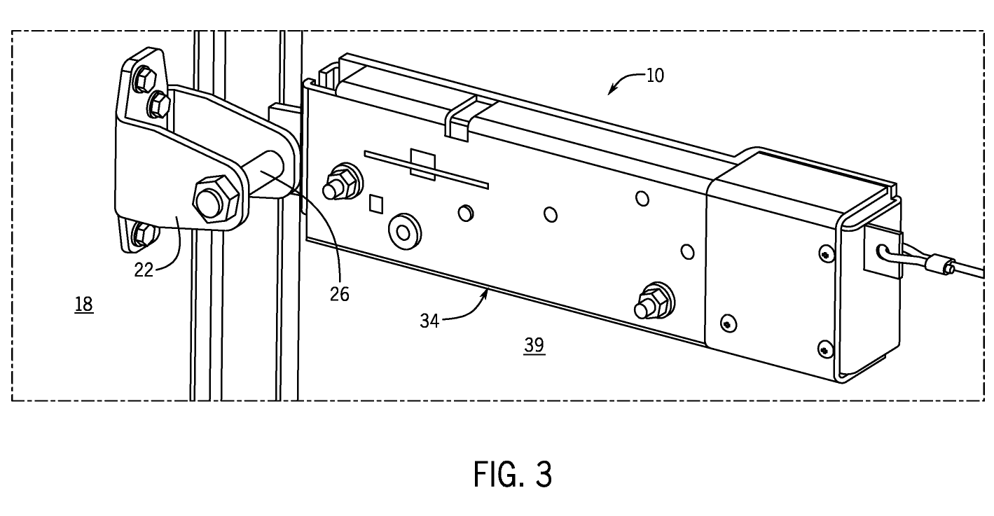

The lock 34 includes a frame plate 42 adapted to mounted on a structure 39 in the space 14 and adjacent the door 18. In the illustrated embodiment, the frame plate 42 is adapted to be mounted to a side wall 39 adjacent a side edge 41 of the door 18. In other embodiments (not shown), the frame plate can be mounted in a similar location on a floor in the cargo area. In other embodiments (not shown), the frame plate can also be used with other styles of doors, such as hinged trailer doors, anywhere the lock 34 can be positioned to catch and hold a strike 26. As illustrated in FIG. 3, line lock assembly is mounted by having the striker bracket 22 secured to the door 18 with self drilling screws. The lock 34 is mounted to the side wall at 3 points (2 shown) using carriage bolts that insert from exterior of the side wall 38 and are then secured with nuts at the interior.

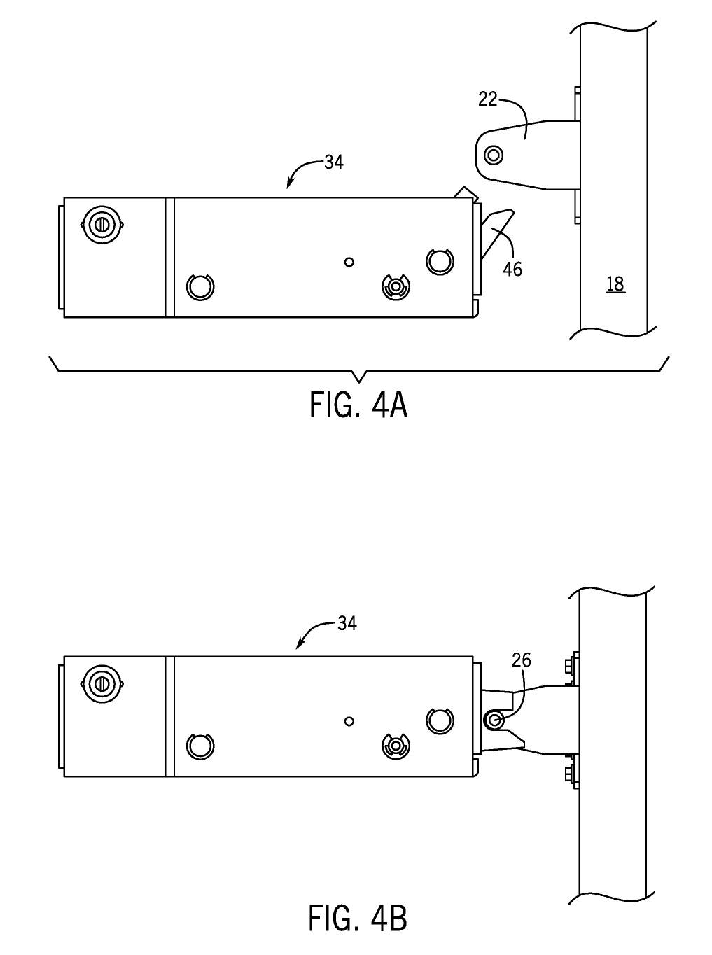

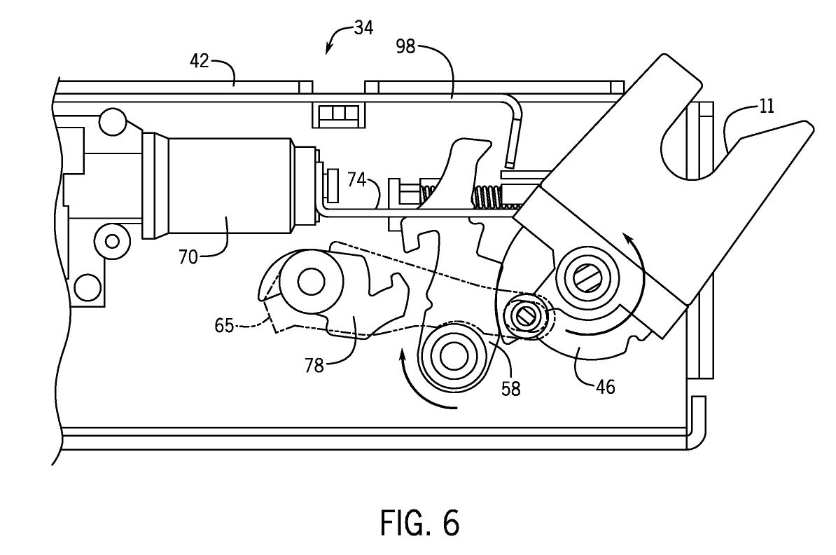

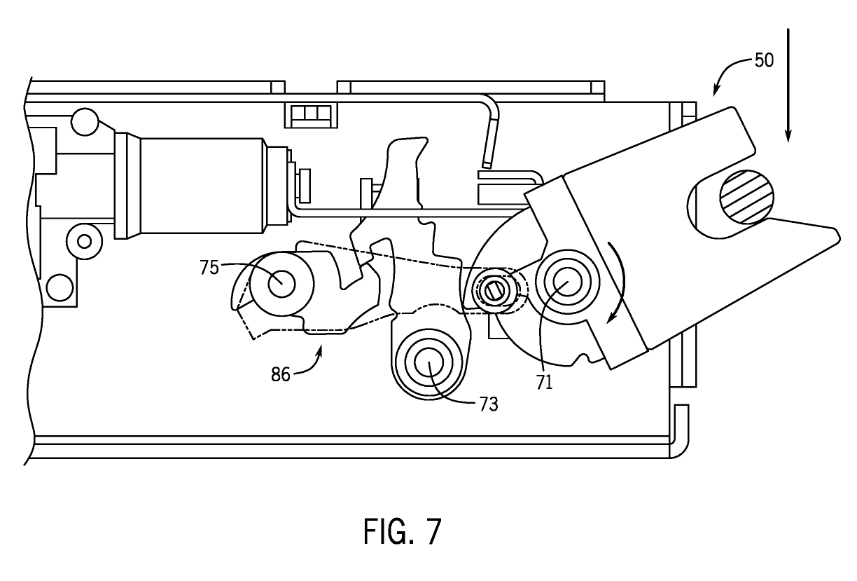

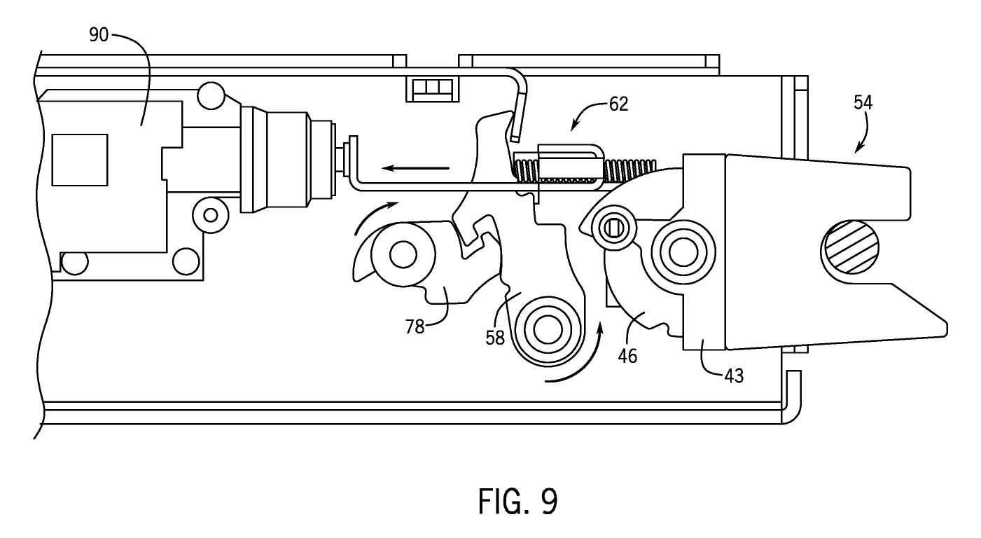

As illustrated in FIG. 4, the lock 34 also includes a catch 46 pivotally mounted by a catch pivot pin 71 on the frame plate 42 and movable by a catch spring 53 between a striker accept position 50 (see FIGS. 4A and 7) and a striker received position 54 (see FIGS. 4B and 9). The striker 28 is receivable in a catch notch 11 (see FIG. 6). The lock 34 is adapted to be positioned where the catch 46 can receive and hold the striker 26. As illustrated in FIG. 4, the lock assembly 10 works such that when the door 18 closes, the striker 26 engages the catch 46 and swings it down to the locked position. The striker 26 remains engaged with the catch 28 until someone opens the cargo door 18.

When the door 18 is closed, the catch 26 is engaged and holds the striker 26, preventing upward movement of door 18 (see FIG. 4B). The lock assembly 10 locks automatically at this point. The lock assembly 10 can only be unlocked with a FOB, a key or with a manual cable before the door 18 can be opened again, as further explained below.

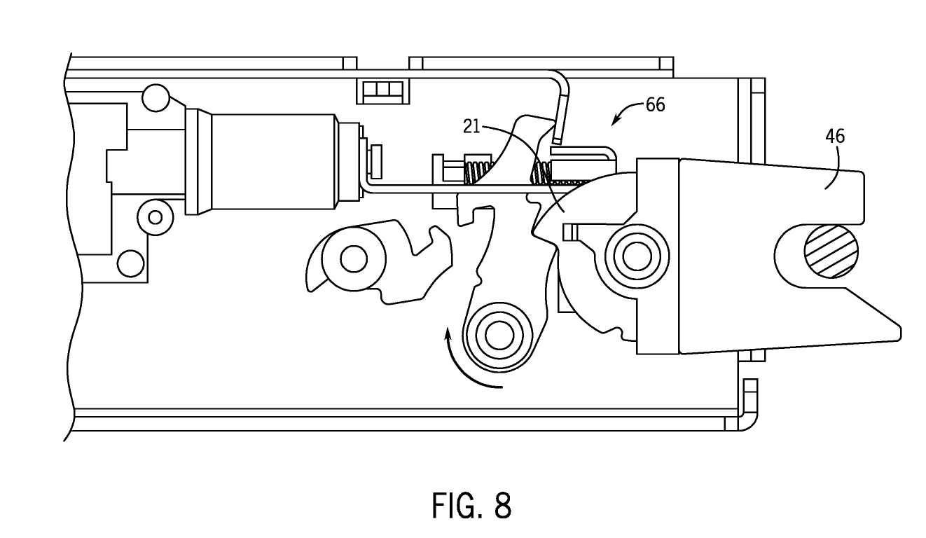

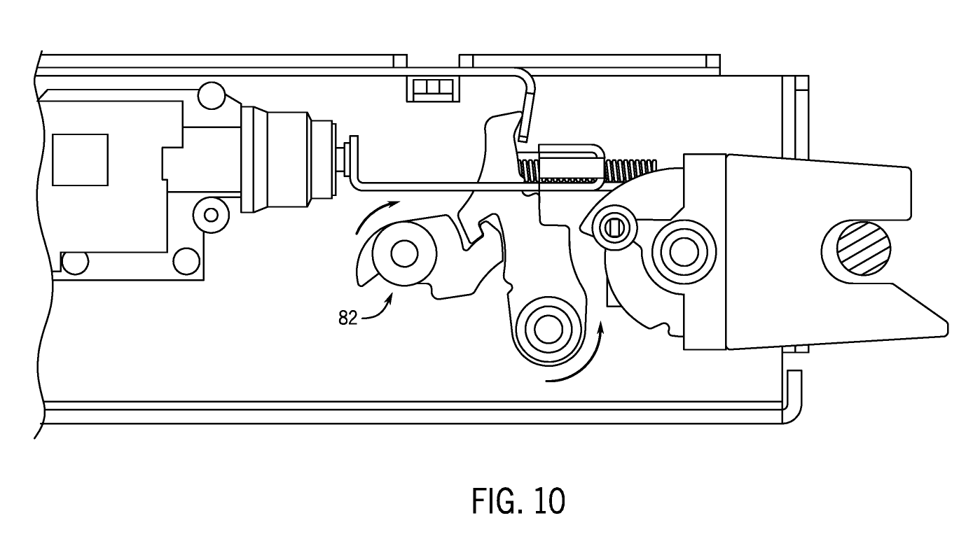

The lock 34 also includes a pawl 58 pivotally mounted on the frame plate 42 by a pawl pivot pin 73 and movable by a pawl spring 27 between a catch release position 62 (see FIG. 9) and a catch kick position 66 (see FIG. 8). The lock 34 also includes an actuator 70 attached to the frame plate 42. The lock 34 also includes an actuator bracket 74 extending from the actuator 70, and movable to engage the pawl 58 and move the pawl 58, and a release cam latch 78 pivotally mounted by a release cam pivot pin 75 on the frame plate 42 and movable between a pawl engaging position 32 (see FIG. 10) and a pawl release position 86 (see FIG. 7). As shown in FIG. 6, the pawl 58 rides on top of the catch 46 and is spring loaded clockwise. The catch spring 27 rotates the catch 26 counterclockwise to the open position shown in FIG. 6, making it ready to accept the striker 26. As shown in FIG. 7, the pawl rides on the catch and starts camming out while the catch closes. And as shown in FIG. 8, when the door (and striker) is fully closed, a catch abutment 21 on the catch 46 clears the pawl 58 and the pawl 58 snaps clockwise, engaging the catch abutment 21.

The lock 34 also includes a controller 90 mounted within the frame plate 42 for operating the actuator 70, and a FOB unlock button (not shown) wirelessly connected to the controller 90. A FOB (not shown) Is a conventional small security hardware device with built-in authentication used to control and secure access to the space. When the FOB unlock button is pushed, it sends a signal to the actuator 70 to fire. As shown in FIG. 9, the actuator 70 pulls back on the actuator bracket 74, which in turn rotates the pawl 58, disengaging it from the catch 46. At the end of its travel, the pawl 58 cams the release cam latch 78 open.

The lock 34 further includes a lock linkage 98 slidably mounted on the frame plate 42 and movable to engage the pawl 58 and move the pawl 58, and a lock cylinder 98 mounted within the frame plate 42 and attached to the lock linkage 98 for moving the lock linkage 98. Further, the lock 34 includes a manual release handle 97 attached to the lock linkage 98 for moving the lock linkage 98.

The latch style lock assembly 10 secures the rolling cargo door 18 useful for delivery trucks, garages, etc. There are the three unlocking methods, either power actuation with a FOB (not shown), the lock cylinder 95 and key (not shown) actuation, and manual actuation with the cable release 97 from within cargo area 14.

The lock assembly 10 is designed to mount anywhere in the space 14 (cargo area), from floor level all the way up to the ceiling of the cargo area 14. The lock assembly 10 is designed to be an add-on to the door 18, and it can be added to existing door installations.

The lock assembly 10 locks automatically when the door 18 is closed, but the lock assembly 10 can be modified to give lock and unlock capability. In other words, the lock assembly can be modified to only lock upon the turning of a key (not shown), for example.

As shown in FIG. 10, at the end of release cam latch's travel, release cam latch 78 holds the pawl 58 in the unlocked state. This feature is required because the catch spring 27 would not be strong enough to move the catch 46 with the heavy cargo door 18 holding it in that position. After the unlock button on the FOB is released, the pawl 58 will spring back to its locked position with the catch 46, preventing the door 18 from opening.

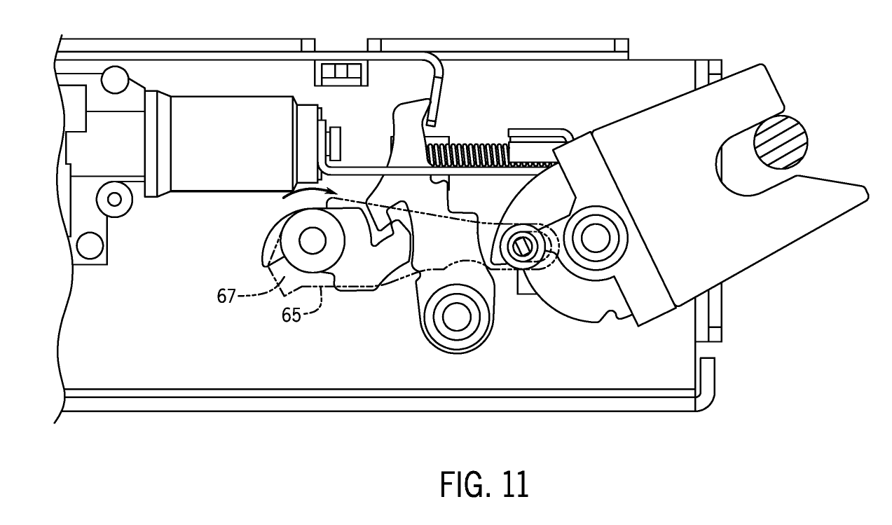

The catch 46 rotates a release earn 65 through a catch plate 43. The release earn 65 then rotates the release cam latch 78, disengaging the pawl 58, allowing the system to be reset and ready to be locked a pairs. The release cam 65 drives the release cam latch 78 through a release cam abutment 67 (see FIG. 11). And the striker 26 pulls up on the catch 46 when the door 18 is opened. As shown in FIG. 11, when the door 18 opens, the striker 26 pulls open the catch 46. A release cam 65 extends between the catch plate 43 and the release cam latch 78 and is operable to rotate the release cam latch 78.

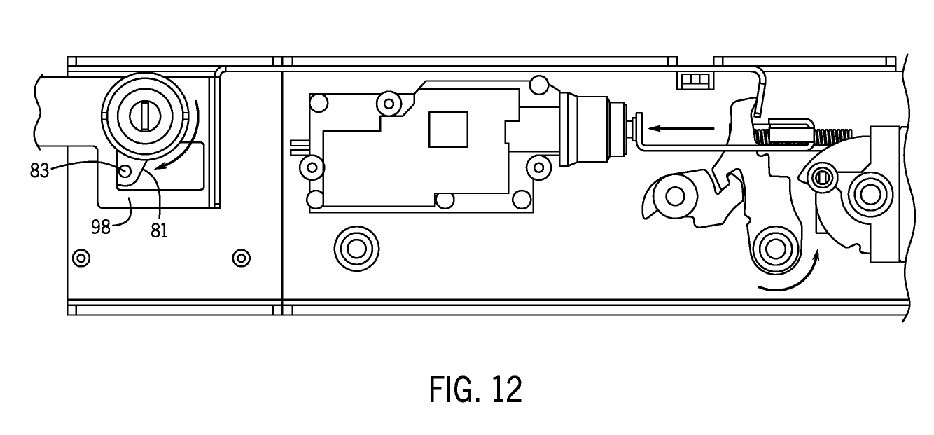

When a key is turned, the lock linkage 98 pulls on the pawl 58, rotating it to the unlocked slate, as shown in FIG. 12. And when a key is rotated clockwise, a lock pawl 81 and a lock pawl pin 83 at the end of the lock pawl 81 pulls on the lock linkage 98.

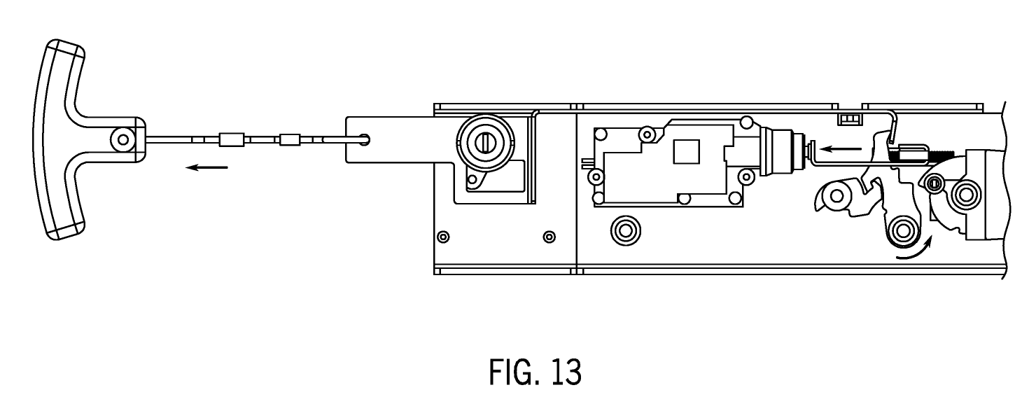

As shown in FIG. 13, the manual release handle 97 is attached directly to the lock linkage 98. When pulsed, the lock linkage 98 rotates the pawl 58 to the unlocked state.

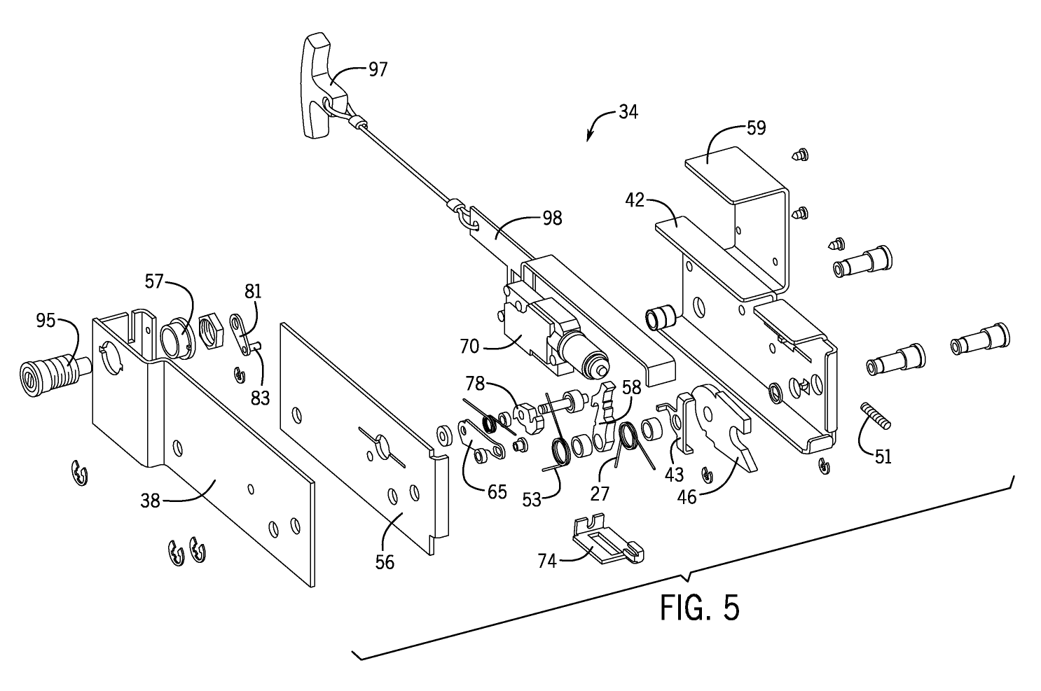

FIG. 5, an exploded view of the lock 34, further illustrates how the lock 34 also includes a catch plate 43, a return spring 51, a pawl spring 53, a cover plate 56, a lock plug 57 and a lock cover 59.

Various other features of this disclosure are set forth in the following claims.

1. A latch style lock assembly adapted to secure a space enclosed by a door, the lock assembly comprising:
a striker adapted to be attached to the door, and a lock including;
a frame plate adapted to mounted m the space adjacent the door,
a catch pivotally mounted on the frame plate and movable between a striker accept position and a striker received position, the lock being adapted to be positioned where the catch can receive and hold the striker,
a pawl pivotally mounted on the frame plate and movable between a catch release position and a catch lock position.
an actuator attached to the frame plate, and
an actuator bracket extending from the actuator, the actuator bracket being movable to engage the pawl and move the pawl.

2. The latch style lock assembly according to claim 1 and further including a controller mounted within the frame plate for operating the actuator.

3. The latch style lock assembly according to claim 1 and further including a manual release handle attached to the lock linkage for moving the lock linkage.

4. A latch style lock assembly adapted to secure a space enclosed by a door, the lock assembly comprising:
a striker adapted to be attached to the door, and a lock including:
a frame plate adapted to mounted in the space adjacent the door,
a catch pivotally mounted on the frame plate and movable between a striker accept position and a striker received position, the lock being adapted to be positioned where the catch can receive and hold the striker,
a pawl pivotally mounted on the frame plate and movable between a catch release position and e catch lock position,
an actuator attached to the frame plate,
an actuator bracket extending from the actuator, the actuator bracket being movable to engage the pawl and move the pawl,
a catch plate rotatable with the catch,
a release cam latch pivotally mounted on the frame plate and movable between a pawl engaging position and a pawl release position
a release cam extending between the catch plate and release earn latch and operable to rotate the release cam latch,
lock linkage slidably mounted on the frame plate and movable to engage the pawl and move the pawl, and
a lock cylinder mounted within the frame plate and attached to the lock linkage for moving the lock linkage.

5. The latch style lock assembly according to claim 4 and further including a controller mounted within the frame plate for operating the actuator.

8. The latch style lock assembly according to claim 5 and further including a manual release handle attached to the lock linkage for moving the lock linkage.
